(19) United States
(12) Patent Application Publication
(10) Pub. No.: US 2007/0264186 A1
(43) Pub. Date: Nov. 15, 2007

(54) Process for Production of Hydrogen and/or Carbon Monoxide

(76) Inventors: Ib Dybkjaer, Copenhagen K (DK); Anne Krogh Jensen, Allerod (DK); Carsten Lau Laursen, Charlottenlund (DK); Henrik Otto Stahl, Rungsted Kyst (DK)

Correspondence Address: DICKSTEIN SHAPIRO LLP, 1825 EYE STREET NW, Washington, DC, 20006-5403, US

(21) Appl. No.: 11/660,669

(22) PCT Filed: Sep. 2, 2005
(86) PCT No.: PCT/EP05/09472

§ 371 Date: Feb. 21, 2007

(30) Foreign Application Priority Data
Sep. 9, 2004 (DK) PA 2004 01364

(51) Int. Cl. C01B 3/38; B01J 8/06; C01B 31/18

(52) U.S. Cl. 423/418.2; 423/437.2; 423/648.1; 585/752

(57) ABSTRACT

A process for production of hydrogen and/or carbon monoxide rich gas from gaseous or liquid hydrocarbon feed-stock comprising the following steps: (a) desulphurisation of the hydrocarbon feed (1), mixing the feed (1) with steam (4) produced from waste heat in the process, feeding the mixture (6, 7) to a steam reforming section (8, 9) for conversion of the hydrocarbon feed by reaction with steam to form a process gas (12) comprising a mixture of hydrogen, carbon monoxide, carbon dioxide, residual methane and excess steam, (b) cooling the process gas (12) by steam production, (c) separating hydrogen and/or carbon monoxide (21) by conducting the process gas through a hydrogen and/or carbon monoxide purification section (20), (d) adding essentially all off-gas (22) from the purification section (20) as fuel to the reforming section (8, 9) to provide heat for the reforming reaction, (e) recovering hot flue gas (32) from the reforming section and cooling the hot flue gas at least partly by steam production, (f) recovering essentially all steam produced by cooling of process gas (12) and flue gas (32) as process steam (4), wherein the reforming section comprises at least two reforming reactors (8, 9) fed in parallel with the feed mixture of hydrocarbon feedstock (6, 7) and steam (4) and fired so that fuel (25, 26) is added in parallel to burners (29, 31) in the reforming reactors (8, 9), whereas combustion air (27) is added to a first reforming reactor (8) in an amount required to ensure a suitable adiabatic flame temperature and the partly cooled flue gas (30) from the first reforming reactor is used as combustion air in the at least one subsequent reforming reactor (9) arranged in series with respect to said combustion air in an amount required to ensure a suitable adiabatic flame temperature

The present invention relates to a process and apparatus for the production of hydrogen and/or carbon monoxide rich gas by steam reforming of hydrocarbon feed. In particular the invention relates to a process for the production of hydrogen and/or carbon monoxide without co-production of excess steam and with increased thermal efficiency.

It is well-known in the art to produce hydrogen and/or carbon monoxide by steam reforming of hydrocarbon feed, cooling of the product process gas from the steam reforming by steam production, followed by carbon monoxide conversion, further cooling, separation of condensed water, and purification of hydrogen and/or carbon monoxide by appropriate means. Where hydrogen is the desired product gas, such purification may comprise the steps of carbon dioxide removal followed by methanation or by passage through a PSA-unit (Pressure Swing Adsorption). The purification may include the steps of separation of part of the hydrogen in a membrane, where a mixture of hydrogen and carbon monoxide is the desired product or by carbon dioxide removal followed by cryogenic separation or another process useful for carbon monoxide recovery, where carbon monoxide is a desired product. In the last case, the hydrogen-rich off-gas from the carbon monoxide recovery unit may be further treated, e.g. in a PSA unit, for recovery of pure hydrogen as a second desired product.

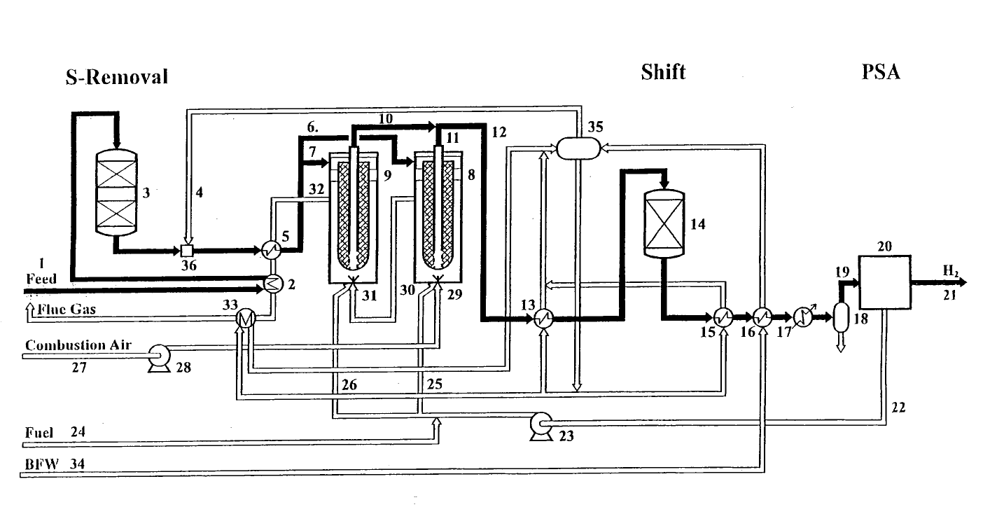

Since steam reforming is a highly endothermic process, it is conventional to carry out the reforming reactions of the hydrocarbon feed in catalyst-filled tubes in radiant furnaces, for instance as described in U.S. Pat. No. 5,932,141 and FIG. 2 of publication “Revamp options to increase hydrogen production” by I. Dybkjær, S. Winter Madsen and N. Udengaard, Petroleum Technology Quarterly, Spring 2000, page 93-97. In such reforming units heat is supplied by external combustion by means of a number of burners arranged in the furnace wall at different levels operated with a low surplus of air, typically 5-20% above the stoichiometric amount (i.e. the amount of air which contains exactly the amount of oxygen required for complete combustion of all combustible components in the fuel), so as to provide for a high adiabatic flame temperature (i.e. the temperature that would be achieved from the fuel and air or oxygen containing gas if there is no exchange of enthalpy with the surroundings), for example 2000° C. or higher. The heat for the reforming reaction is thereby supplied by radiation from the hot gas and from the furnace walls to the reformer tubes, wherein solid catalyst is disposed and to a minor extent by convection from the flue gas, which leaves the furnace at high temperature, typically about 1000° C. In many practical situations steam is of little value and steam export is therefore not desirable. In this type of reforming process using a radiant furnace (tubular reformer), it is not possible to adjust the conditions in such a way that production of excess steam is avoided. In addition, only about 50% of the fired duty is transferred to the reformer tube wall, thus requiring constant external fuel input. Thermal efficiency in the steam reforming process is accordingly low.

Another type of reforming process is heat exchange reforming and more particularly the so-called convective reforming, where the heat required for the reforming reactions is provided mainly by convection from the flue gas to the catalyst-filled tubes wherein the reactions take place. In convection reforming units the adiabatic flame temperature must be below a certain maximum value, which depends on the tolerance of the materials used for the construction of the tubes of the reformer as well as other mechanical parts of the reforming unit because the flue gas at the adiabatic flame temperature is in direct contact with the reformer internals which could be damaged at too high temperatures. When atmospheric air is used a high excess of combustion air, typically about 100% or more above the stoichiometric ratio, is required. When leaving the reforming unit after having supplied heat to the reforming reaction, the flue gas still contains significant amounts of oxygen, typically about 10% v/v or higher, and is typically at a temperature of about 600° C. The latent heat in the process gas and in the flue gas leaving the reformer is most often used for steam production and for preheating of the hydrocarbon feed.

EP patent application No. 0 535 505 describes such a reforming process in a particular type of heat exchange reactor comprising bayonet tubes, i.e. tubes in which the catalyst is placed in the annular space between an outer tube and an inner tube, and in which the hydrocarbon feed first passes through the catalyst-containing annular space in one direction, and then through the inner, empty (catalyst-free) tube in the opposite direction. Apart from the heat provided by the flue gas flowing outside the bayonet tubes, additional heat is supplied by the reformed gas flowing through the bayonet's inner tubes. This type of reactor is also referred to in the art as convection reformer. It is composed of a plurality of bayonet tubes inside a refractory lined shell and is particularly suitable for high pressure applications and relatively large capacities, e.g. up to about 10.000 Nm³/h hydrogen. Contrary to radiant furnaces, the convection reformer is provided with a single burner often separated from the reformer tube section, thereby simplifying the design and operation of the reformer.

U.S. Pat. No. 5,925,328 describes a process particularly suitable for the preparation of ammonia synthesis gas. The process comprises at least two heat exchange reforming units, preferably of the conventional bayonet tube type as described above, in which the hydrocarbon feed gas is split in parallel streams that are admixed with steam and deoxygenised flue gas prior to entering each of the reforming units. Each unit comprises a fuel inlet and a combustion oxidant inlet. Said combustion oxidant is introduced in high excess (about 100% of stoichiometric ratio) as compressed air to the burner in the first reforming unit together with a fuel stream so that the flame temperature is kept below about 1400° C. The compressed air, now partially depleted of oxygen and having exchanged heat with the reformer tubes, leaves the first reforming unit as a flue gas of temperature about 600° C. and is used as combustion air in the second reforming unit. The flame temperature in said second unit is also kept below 1400° C. The flue gas from the second unit is further depleted from oxygen so as to produce a gas stream consisting mainly of nitrogen, carbon dioxide and water. Part of this gas stream is treated to remove any remaining oxygen and is then admixed to the hydrocarbon feed gas stream. The amount of this flue gas can be selected so as to obtain a suitable hydrogen-to-nitrogen ratio for ammonia synthesis in the product gas leaving the last reforming unit. This citation specifies the need for a deoxygenation unit for depletion of oxygen in the flue gas from the second reformer and is silent about the use of a unit or units for purification of hydrogen and/or carbon monoxide and consequently also silent about the use of the off-gas from the purification unit as fuel. External fuel input is also necessary to sustain the reforming reactions due to the requirement of about 100% excess air in the first reforming unit. Accordingly, the feed and fuel consumption is relatively high.

Another type of convection reforming process is disclosed in the publication “Medium size hydrogen supply using the Topsøe convection reformer” by I. Dybkjær et al., AM-97-18, presented at 1997 National Petroleum Refiners Association, Annual Meeting, Mar. 16-18, 1997, Convention Center, San Antonio, Tex. The process comprises: desulphurisation of a hydrocarbon feed, admixing with steam, passing the mixed stream through a single convection reformer, cooling the reformed gas by steam production, passing the gas to a shift converter to convert carbon monoxide to hydrogen, further cooling of the gas and final purification of the hydrogen rich gas in a PSA unit. The off-gas from the PSA unit is used as fuel supply for the steam reforming process. Small amounts of external fuel can be used to i.a. ensure flexibility during fuel firing. The flue gas from the convection reformer may be used for steam production, steam superheating, feed preheating and preheating of combustion air to the reformer. In this reforming process comprising only one convection reformer essentially all steam is used as process steam and there is basically no need of external fuel for the convection reformer since all off-gas from the PSA unit is used as fuel. However, the requirement of about 100% excess air in the single convection reformer imposes a great demand on fuel supply so that the required amount of feed per unit volume hydrogen produced and thereby the combined consumption of feed plus fuel is still significantly high.

It would therefore be desirable to provide a process which is able to achieve production of hydrogen and/or carbon monoxide with lower consumption of combined feed plus fuel than in state of the art processes without steam export and with a high thermal efficiency.

We have now surprisingly found that by using at least two steam reforming units in parallel with respect to the hydrocarbon feed and fuel streams and in series with respect to the combustion air, significant advantages are achieved, in particular a high thermal efficiency in the hydrogen and/or carbon monoxide production process, no steam export and low consumption of combined feed and fuel.

According to the invention there is provided a process for production of hydrogen and/or carbon monoxide rich gas from gaseous or liquid hydrocarbon feedstock comprising the following steps:
desulphurisation of the hydrocarbon feed, mixing the feed with steam produced from waste heat in the process, feeding the mixture to a steam reforming section for conversion of the hydrocarbon feed by reaction with steam to form a process gas comprising a mixture of hydrogen, carbon monoxide, carbon dioxide, residual methane and excess steam,
cooling the process gas by steam production,
separating hydrogen and/or carbon monoxide by conducting the process gas through a hydrogen and/or carbon monoxide purification section,
adding essentially all off-gas from the purification section as fuel to the reforming section to provide heat for the reforming reaction,
recovering hot flue gas from the reforming section and cooling the hot flue gas at least partly by steam production,
recovering essentially all steam produced by cooling of process gas and flue gas as process steam,

wherein the reforming section comprises at least two reforming reactors fed in parallel with the feed mixture of hydrocarbon feedstock and steam and fired so that fuel is added in parallel to burners in the reforming reactors, whereas combustion air is added to a first reforming reactor in an amount required to ensure a suitable adiabatic flame temperature and the partly cooled flue gas from the first reforming reactor is used as combustion air in the at least one subsequent reforming reactor arranged in series with respect to said combustion air in an amount required to ensure a suitable adiabatic flame temperature.

The arrangement of at least two reforming units significantly reduces the combined feed and fuel requirements per volume unit of hydrogen and/or carbon monoxide produced.

The amount of steam produced, which is subsequently used as process steam, is reduced due to the reduced amount of combustion air per unit hydrogen produced, and therefore the steam to carbon ratio (S/C-ratio), defined as the molar ratio between steam and carbon contained in the hydrocarbon feed, is reduced compared to the case where e.g. only one reforming reactor is used. This results in a number of benefits, such as:
reduced total flow of gases throughout the hydrogen and/or carbon monoxide production plant leading to smaller equipment and/or lower pressure drop,
reduced heat loss at low temperature by condensation of excess steam with concomitant higher overall energy efficiency (i.e. lower heating value of hydrogen and/or carbon monoxide product plus enthalpy content of possible export steam divided by lower heating value of the hydrocarbon feed and any external fuel added to the process),
where carbon monoxide is a desired product, higher concentration of carbon monoxide and accordingly lower ratio of hydrogen to carbon monoxide in the product process gas from the steam reforming section.

When referring in this specification to the term “production of hydrogen and/or carbon monoxide” it is meant that hydrogen and carbon monoxide can be manufactured as separate or mixed product gas streams. Thus, the product gas stream may be a purified hydrogen stream containing above 96%, preferably above 99% v/v hydrogen. The product stream may be a purified carbon monoxide stream containing above 96%, preferably above 99% v/v carbon monoxide. The product stream may also be a stream containing a mixture of hydrogen and carbon monoxide having a predetermined molar ratio hydrogen-to-carbon monoxide of 4:1, often 3:1, more often 2:1; preferably 1:1.

The invention also includes the plant (apparatus) which is used for producing the hydrogen and/or carbon monoxide, such as the means for desulphurisation and/or other necessary purification of the hydrocarbon feed, means for mixing the hydrocarbon feed with steam and for reforming the feed and steam mixture, means for cooling the combined product gas from the reforming section and for any further conversion and purification of the process gas into hydrogen and/or carbon monoxide, and the recycling system of essentially all off-gas from the hydrogen and/or carbon monoxide purification unit used as fuel in the reforming section, including the at least two reforming reactors arranged in series with respect to the combustion air being supplied to the reforming reactors.

The number of reforming reactors depends on the amount and composition of fuel leaving the hydrogen and/or carbon monoxide purification unit. In a preferred embodiment, the process is carried out in two reforming reactors connected in parallel with respect to the hydrocarbon feed stream and the fuel stream and connected in series with respect to the combustion air. A preferred level of oxygen in the final flue gas (from the last reforming reactor) is less than 2% v/v. Higher levels of oxygen are less desirable because it increases the heat loss with the excess air added, thus reducing the overall energy efficiency of the process as defined above. In particular, when operating the process with two reforming reactors and where the fuel essentially consists of off-gas from a PSA unit (for hydrogen recovery), the desired level of oxygen in the flue gas from the last reforming reactor of less than 2% v/v is obtained. Preferably, the reforming reactors are convection reforming reactors.

It is possible to operate the process and plant so that it is economically and environmentally advantageous, that is, less need for combined fuel and hydrocarbon feed and less exhaust of carbon dioxide per unit hydrogen and/or carbon monoxide produced, compared to conventional processes.

The invention also includes the preheating of hydrocarbon feed and/or feed mixture of hydrocarbon feed and steam by indirect heat exchange with hot flue gas from the reforming section.

The combustion air is preferably added to the first reforming reactor as fresh air in an amount ensuring that the flame temperature during combustion does not exceed about 1400° C.; preferably this temperature is below 1300° C., for example in the range 1100-1300° C. in order to avoid damage of the reactor materials, for instance tubes, being in direct contact with the hot gas from the combustion. By suitable adiabatic flame temperature as referred hereinbefore is meant therefore temperatures not exceeding about 1400° C. Thus, in this specification, the terms adiabatic flame temperature, flame temperature and temperature of combustion are used interchangeably. These terms mean the temperature that would be achieved from the fuel and air (oxygen-containing gas) if there is no exchange of enthalpy with the surroundings. Flue gas from said first reforming reactor is then added as combustion air to the second reforming reactor, while the flue gas from said second reactor may be used as combustion air for an optionally third reactor. Additional reforming reactors may be arranged accordingly.

The invention also includes the recovering of hot flue gas from the reforming section, that is, the at least two reforming reactors and cooling the hot flue gas at least partly by steam production. Accordingly, part of the flue gas stream of any reforming reactor may be diverted and used for other purposes than as combustion air. For instance, part of the flue gas from the first reforming reactor may be used for preheating of the hydrocarbon feed or hydrocarbon feed—steam mixture and for production of steam to be used in the process. Preferably, all hot flue gas recovered from the reforming section is flue gas from the last reforming reactor. By hot flue gas is meant gas having a temperature of below about 700° C., for example 450-650° C., preferably about 600° C.

The flue gas from the last reforming reactor may be used for indirect heat exchange of the hydrocarbon feed, for example by indirect heat exchange before and/or after a conventional desulphurisation step upstream the reforming reactors. The flue gas from said last reforming reactor may also be used as heat exchanging medium for production of steam to be used in the process. It is also possible to divert part of the flue gas stream from said last reforming reactor so as to serve as additional combustion air in any preceding reforming reactor. This provides the benefit of easier control of flame temperature during combustion, thereby ensuring a suitable flame temperature, this preferably being below about 1400° C.

The invention includes recovering essentially all steam produced by cooling of process gas and flue gas as process steam. When referring to the term “recovering essentially all steam produced” it is meant that process gas (reformed gas) and flue gas are cooled to produce steam, in which at least 90%, preferably at least 95%, more preferably at least 99% w/w of the produced steam is recovered in the process by admixing said steam to the feed stream to the reforming reactors after retracting any steam required in the purification section, so that inexpedient steam export is avoided. Thus, steam is produced from waste heat in the process. No latent heat in the flue gas needs to be recovered for power production.

The hydrocarbon feed stream consists of any gas suitable to be converted by steam reforming for the production of hydrogen, such as natural gas, naphtha, LPG and off-gases from refinery processes. Prior to entering the reforming section, the hydrocarbon feed stream is mixed with steam so that the steam-to-carbon ratio in the gas (ratio of moles of water to moles of carbon) is in a range acceptable for the steam reforming reactors, for example 0.5 to 10, preferably 1 to 5, most preferably 1.5 to 4.

The process gas streams from the reforming reactors are optionally mixed, cooled by suitable means such as a boiler to a suitable temperature by steam production and, where hydrogen is the desired product gas, subjected to a conventional shift-reaction step in which the carbon monoxide of the process gas (reformed gas) is converted by reaction with remaining steam into hydrogen and carbon dioxide, thereby providing further enrichment of the process gas into the desired product, i.e. hydrogen. The shift-reaction is advantageously carried out in a conventional one-step or two-step shift conversion unit, which is positioned downstream afore mentioned means for cooling the product process gas by steam production.

Alternatively, the process streams from each reforming reactor can be cooled separately by steam production before they are mixed and further treated in a shift-converter. It is also possible to cool the process streams from each reforming reactor separately and subject each cooled process stream separately to a shift-conversion step. Where carbon monoxide is a desired product, the shift conversion of one, several or all process gas streams may be avoided.

After the optional shift-reaction step the converted gas stream is further cooled. Preferably this cooling is conducted partly by production of additional steam and/or heating of boiler feed water, by cooling with air and/or cooling water to condense excess steam, and subsequently separating the condensed water from non-condensed gases. When a carbon dioxide removal unit is included in the purification section, the cooling may partially be conducted so as to meet part or all of the heating requirements of said carbon dioxide removal unit.

Purification of the stream of non-condensed gases (hydrogen and/or carbon monoxide-rich process gas stream) is carried out in a conventional hydrogen and/or carbon monoxide purification section comprising units such as PSA units, carbon dioxide removal units, membrane units, and cryogenic units, alone or in combination as required. Where hydrogen is the desired product gas, the preferred hydrogen purification step is a PSA unit. Where carbon monoxide is the desired product gas, the preferred carbon monoxide purification step is a carbon dioxide removal unit comprising means to discard carbon dioxide to the atmosphere or to recycle recovered carbon dioxide to the hydrocarbon feed stream of at least one reforming reactor, and means for conducting a subsequent cryogenic step to recover carbon monoxide as product gas. Where a stream containing hydrogen and carbon monoxide in a predetermined molar ratio is desired, the purification section is preferably a carbon dioxide removal unit comprising means to discard carbon dioxide to the atmosphere or to recycle recovered carbon dioxide to the hydrocarbon feed stream of at least one reforming reactor, followed by a conventional membrane unit. A hydrogen purification unit, such as a PSA unit may advantageously be positioned downstream said membrane unit so as to purify the hydrogen-rich product stream (permeate) from said membrane unit into a hydrogen product stream. Accordingly, the invention also includes a purification step in which said hydrogen-rich stream is further treated in a PSA unit to recover hydrogen as product stream. It would thus be understood that the term “purification section” defines one or more purification units that are used to finally enrich the cooled process gas into hydrogen and/or carbon monoxide.

The off-gas from the purification section comprising one or more purification units, and containing mainly any or all of the components carbon dioxide, hydrogen, methane and carbon monoxide, is recovered and used as gaseous fuel in at least one, preferably all of the reforming reactors so that the supply of external fuel is minimised or completely avoided. Only a small amount (less than 10% of the fuel required in reformer reactors) is normally supplied by an external fuel in order to achieve full flexibility during firing. Accordingly, when referring in this specification to the term “adding essentially all off-gas from the purification section”, it is meant that optionally 0% to 20%, often up to 10%, for example 5% of the amount of fuel required in the reforming reactors is provided by an external fuel source, i.e. a fuel source other than the off-gas from the purification unit. For example, the external fuel source can be a diverted stream from the hydrocarbon feedstock. The invention includes therefore the described process and apparatus for hydrogen and/or carbon monoxide production, wherein additional external fuel is supplied together with off-gas from the purification unit to provide stability and flexibility in firing and additional heat for the reforming reaction. It is to be understood that the term “adding essentially all off-gas from the purification section” excludes the addition of streams which are without value as fuel such as the off gas from a carbon dioxide removal unit.

The invention includes also the preparation of methanol directly obtained by the process. Accordingly, the invention provides a process for the preparation of methanol by:

(a) desulphurisation of the hydrocarbon feed, mixing the feed with steam produced from waste heat in the process, feeding the mixture to a steam reforming section for conversion of the hydrocarbon feed by reaction with steam to form a process gas comprising a mixture of hydrogen, carbon monoxide, carbon dioxide, residual methane and excess steam, said reforming section comprising at least two reforming reactors fed in parallel with the feed mixture of hydrocarbon feedstock and steam and fired so that fuel is added in parallel to burners in the reforming reactors, whereas combustion air is added to a first reforming reactor in an amount required to ensure a suitable adiabatic flame temperature and the partly cooled flue gas from the first reforming reactor is used as combustion air in the at least one subsequent reforming reactor arranged in series with respect to said combustion air in an amount required to ensure a suitable adiabatic flame temperature

(b) cooling the process gas by steam production,

(c) separating hydrogen and/or carbon monoxide by conducting the process gas through a hydrogen and/or carbon monoxide purification section,

(d) adding essentially all off-gas from the purification section as fuel to the reforming section to provide heat for the reforming reaction,

(e) recovering hot flue gas from the reforming section and cooling the hot flue gas at least partly by steam production,

(f) recovering essentially all steam produced by cooling of process gas and flue gas as process steam, and

(g) converting the product gas of step (c) containing hydrogen and/or carbon monoxide to methanol.

The invention is illustrated by reference to the accompanying FIGURE, which shows a flow-sheet for a hydrogen production plant according to a preferred embodiment of the inventive process and plant (apparatus).

Hydrocarbon feed 1 is preheated in heat exchanger 2 by indirect heat exchange with flue gas from the reforming section, desulphurised by conventional means in reactor 3 and mixed with steam 4 in mixing unit 36. The mixture is subjected to heating by heat exchange with flue gas in heat exchanger 5. Alternatively, the steam can be heated separately in heat exchanger 5 before being mixed with the desulphurised feed. The preheated mixture of desulphurised feed and steam is split into parallel streams 6 and 7 which are fed individually to reforming reactors 8 and 9. The reforming reactors are shown with bayonet tubes, but can be any type of reforming reactor heated by combustion air. Product exit gas 10 and 11 from the reforming reactors are mixed into a single process gas stream 12 which is cooled by steam production in boiler 13. The cooled stream is passed to a conventional shift converter unit 14 and the exit gas from said converter unit is further cooled in boiler 15, a boiler feed water (BFW) preheater 16 and one or several final coolers 17. Water is separated from non-condensed gases in separator 18. The condensate is normally sent to treatment, while the non condensed gases 19 are sent to hydrogen purification unit 20 (PSA unit) where most of the hydrogen is separated from other non-condensed gases. The hydrogen is recovered as product 21 while the pressure of the off-gas 22 is raised in blower 23 so as to overcome the pressure drop in burners 29, 31 and reforming reactors 8, 9, before it is used as fuel in the reforming section.

Off-gas 22 is after passage through blower 23 mixed with a small, optional stream of external fuel 24 and thereafter split into streams 25 and 26 which are, respectively, sent to burners 29 and 31 in reforming reactors 8 and 9. Alternatively, only part of the off-gas passes through blower 23 and then to the burner in one of the reforming reactors, whereas the rest of the off-gas is sent directly to the burner in the other reforming reactor. Combustion air 27 is compressed in compressor 28 and sent to burner 29 in the first reforming reactor 8, where it reacts with fuel stream 25. The amount of fuel gas in stream 25 is adjusted so that sufficient heat can be supplied to the reforming reactions in the reforming reactor by cooling the reaction products from the burner to a predetermined temperature of about 600° C., and the amount of combustion air is adjusted to ensure a suitable adiabatic temperature for combustion in the burner not exceeding about 1400° C. The oxygen depleted flue gas 30 from the first reforming reactor 8 is passed directly to burner 31 in second reforming reactor 9 arranged in series with respect to the combustion air, where it burns with the remaining fuel 26 again to reach a temperature of combustion not exceeding about 1400° C.

Flue gas 32 leaves the second reforming reactor at a temperature of about 600° C. and is cooled by indirect heat exchanging in heat exchangers 2 and 5 and in boiler 33 before passing to a stack (not shown). Boiler feed water (BFW) 34 is heated in heat exchanger 16 and used for steam production in units 13, 15 and 33 so that essentially all steam is recovered in recovering means 35 and is used as process steam 4.

The following example shows the advantages of the invention as applied for hydrogen production when compared to prior art processes. Process A corresponds to a conventional hydrogen production process as described in FIG. 2 of publication “Revamp options to increase hydrogen production” by I. Dybkjær, S. Winter Madsen and N. Udengaard, Petroleum Technology Quarterly, Spring 2000, pages 93-97. The process comprises the steps of desulphurising a hydrocarbon feed, addition of steam to ensure a steam to carbon ratio of 3.3, preheating the resulting mixture to 505° C., performing the steam reforming reactions in a single radiant furnace (tubular reformer) containing a plurality of catalyst-filled tubes, cooling of the converted process gas by steam production followed by a conventional shift reaction step, further cooling, separation of condensed water and hydrogen purification in a PSA-unit. The radiant furnace is heated by a number of burners burning off-gas from the PSA unit supplemented by external fuel. An excess of combustion air corresponding to 10% of the stoichiometric ratio is used, with no air preheat. The heat content in the flue gas leaving the radiant furnace at a temperature of about 1000° C. is used for preheat of feed and for steam production. Part of the steam produced in the unit is used for process steam while the excess is available as export steam.

Process B describes a process with a single convection reformer of the bayonet tube type, as described by I. Dybkjær et al., AM-97-18, presented at 1997 National Petroleum Refiners Association, Annual Meeting, Mar. 16-18, 1997, Convention Center, San Antonio, Tex.

Process C describes the process according to a preferred embodiment of the invention, as illustrated in the accompanying figure, i.e. comprising two convection reformers of the bayonet tube type.

It is observed that inventive process C results in that the combined demand for feed plus fuel is significantly reduced with respect to prior art processes A and B. In addition, thermal efficiency of the reforming section is significantly increased from poor 43% in process A and modest 76% in process B to highly satisfactory and highly surprising 90% in the inventive process C. Thermal efficiency is defined as the heat transferred from combusted gas and converted process gas to the catalyst-filled tubes in the reforming reactor(s) divided by the lower heating value of the combined PSA off-gas and external fuel. The S/C-ratio is also surprisingly reduced in inventive Process C having two convection reformers compared to conventional Process B having one single convection reformer.

### EXAMPLE

| | Process A | Process B | Process C |
|---|---|---|---|
| Feed (Gcal/1000 Nm³ | 2.94 | 3.33 | 3.08 |
| H₂) | | | |
| Fuel (Gcal/1000 Nm³ | 1.34 | 0.11 | 0.07 |
| H₂) | | | |
| Feed + Fuel | 4.28 | 3.44 | 3.15 |
| (Gcal/1000 Nm³ H₂) | | | |
| Steam export | 1572 | 0 | 0 |
| (kg/1000 Nm³ H₂) | | | |
| Thermal efficiency | 43.1 | 75.7 | 90.4 |
| (%) | | | |
| Steam-to-carbon ratio | 3.30 | 3.44 | 2.53 |
| (S/C-ratio) | | | |

1. A process for production of hydrogen and/or carbon monoxide rich gas from gaseous or liquid hydrocarbon feed-stock comprising the following steps:
(a) desulphurisation of the hydrocarbon feed, mixing the feed with steam produced from waste heat in the process, feeding the mixture to a steam reforming section for conversion of the hydrocarbon feed by reaction with steam to form a process gas comprising a mixture of hydrogen, carbon monoxide, carbon dioxide, residual methane and excess steam,
(b) cooling the process gas by steam production,
(c) separating hydrogen and/or carbon monoxide by conducting the process gas through a hydrogen and/or carbon monoxide purification section,
(d) adding essentially all off-gas from the purification section as fuel to the reforming section to provide heat for the reforming reaction,
(e) recovering hot flue gas from the reforming section and cooling the hot flue gas at least partly by steam production,
(f) recovering essentially all steam produced by cooling of process gas and flue gas as process steam, wherein
the reforming section comprises at least two reforming reactors fed in parallel with the feed mixture of hydrocarbon feedstock and steam and fired so that fuel is added in parallel to burners in the reforming reactors, whereas combustion air is added to a first reforming reactor in an amount required to ensure an adiabatic flame temperature of below 1400° C. and the partly cooled flue gas from the first reforming reactor is used as combustion air in the at least one subsequent reforming reactor arranged in series with respect to said combustion air in an amount required to ensure an adiabatic flame temperature of below 1400° C.

2. A process according to claim 1, wherein step (a) further comprises preheating of hydrocarbon feed and/or feed mixture of hydrocarbon feed and steam by indirect heat exchange with hot flue gas from the reforming section.

3. A process according to claim 1, wherein step (b) further comprises feeding all or part of the cooled process gas to a shift conversion step for conversion of carbon monoxide to carbon dioxide by reaction with steam under formation of additional hydrogen.

4. A process according to claim 3, wherein the process gas from said shift conversion step is further cooled partly by production of additional steam and/or heating of boiler feed water, finally cooling with air and/or cooling water to condense excess steam and separating the condensed water from non-condensed gases.

5. A process according to claim 1, wherein the at least two reforming reactors are convection reforming reactors.

6. A process according to claim 1, wherein said purification section consists of a hydrogen purification section.

7. A process according to claim 6, wherein said hydrogen purification section includes a pressure swing adsorption (PSA) unit.

8. A process according to claim 1, wherein said purification section consists of a carbon monoxide purification section.

9. A process according to claim 8, wherein said carbon monoxide purification section includes a carbon dioxide removal unit comprising discarding recovered carbon dioxide to the atmosphere or recycling recovered carbon dioxide to the hydrocarbon feed stream of the at least one reforming reactor, followed by a cryogenic step to recover carbon monoxide as product gas.

10. A process according to claim 1, wherein said purification section is a carbon dioxide removal unit comprising discarding recovered carbon dioxide to the atmosphere or recycling recovered carbon dioxide to the hydrocarbon feed stream of the at least one reforming reactor followed by a membrane unit that is able to recover a stream containing hydrogen and carbon monoxide in a predetermined molar ratio.

11. A process according to claim 1, wherein the process gas from step (b) is further cooled partly by production of additional steam and/or heating of boiler feed water, finally cooling with air and/or cooling water to condense excess steam, and separating the condensed water from non-condensed gases.

12. A process according to claim 1, wherein additional external fuel is supplied together with off-gases from the purification section to provide heat in the reforming section.

13. A process for the preparation of methanol from gaseous or liquid hydrocarbon feedstock comprising the following steps:
(a) desulphurisation of the hydrocarbon feed, mixing the feed with steam produced from waste heat in the process, feeding the mixture to a steam reforming section for conversion of the hydrocarbon feed by reaction with steam to form a process gas comprising a mixture of hydrogen, carbon monoxide, carbon dioxide, residual methane and excess steam, said reforming section comprising at least two reforming reactors fed in parallel with the feed mixture of hydrocarbon feedstock and steam and fired so that fuel is added in parallel to burners in the reforming reactors, whereas combustion air is added to a first reforming reactor in an amount required to ensure a an adiabatic flame temperature of below 1400° C. and the partly cooled flue gas from the first reforming reactor is used as combustion air in the at least one subsequent reforming reactor arranged in series with respect to said combustion air in a suitable an adiabatic flame temperature of below 1400° C,
(b) cooling the process gas by steam production,
(c) separating hydrogen and/or carbon monoxide by con-ducting the process gas through a hydrogen and/or carbon monoxide purification section,
(d) adding essentially all off-gas from the purification section as fuel to the reforming section to provide heat for the reforming reaction,
(e) recovering hot flue gas from the reforming section and cooling the hot flue gas at least partly by steam production,
(f) recovering essentially all steam produced by cooling of process gas and flue gas as process steam, and
(g) converting the product gas of step (c) containing hydrogen and/or carbon monoxide to methanol
